(19) United States
(12) Patent Application Publication
(10) Pub. No.: US 2026/0098546 A1
(43) Pub. Date: Apr. 9, 2026

(54) MITIGATION STRATEGY FOR AIRFOIL CRACKS FOR INTEGRALLY BLADED ROTORS

(71) Applicant: Pratt & Whitney Canada Corp., Longueuil, Québec (CA)

(72) Inventors: Dikran Mangardich, Richmond Hill, Ontario (CA); Paul Stone, Guelph, Ontario (CA)

(21) Appl. No.: 18/910,648

(22) Filed: Oct. 9, 2024

(51) Int. Cl. F04D 29/32

(52) U.S. Cl. CPC F04D 29/324; F01D 5/147; F01D 5/141; F01D 5/143; F01D 5/145; F01D 5/34; F05D 2230/53; F05D 2260/941

(57) ABSTRACT

An integrally bladed rotor (IBR) is provided. The IBR includes a hub and blades. Each blade includes an airfoil section to aerodynamically interact with a flow of air for compressing the air and a root fillet integrally formed with the hub and from which the airfoil section integrally extends. The root fillet includes a curved exterior surface having points of tangency with the airfoil section to define an outboard extent of the root fillet and a root fillet body between the hub and the outboard extent of the root fillet and defining a cutout for arresting a crack that is most likely to form and propagate.

### BACKGROUND

The present disclosure relates gas turbine engines and, more particularly, to a mitigation strategy for known hazardous modes of airfoil cracks for integrally bladed rotors (IBRs).

A turbine is used to generate power for propulsion, in some cases, by turning propellors, fans or helicopter blades through a gearbox. In some instances, the gearbox output is used to power electrical generators. In a gas turbine engine, fuel and compressed oxygen are combusted in a combustor to produce a high-temperature and high-pressure fluid. This fluid enters a turbine and interacts with rows or stages of turbine blades and vanes. This interaction causes the stages of turbine blades to rotate a rotor. The rotor rotation drives a compressor to compress the oxygen for the combustor and, as noted above, can be used to drive operations of a generator to produce electricity or for propulsion.

Within the compressor, inlet air is partially compressed by flowing through a series of interleaved compressor vane stages and compressor blade stages. The compressor vane stages can be stationary whereas each of the compressor blade stages rotates as a singular element about a rotational axis of the gas turbine engine. In some cases, each compressor blade stage can be provided as an IBR in which a rotor hub and blades as assembled as a single part with the blades being integrally formed with the hub.

### BRIEF DESCRIPTION

According to an aspect of the disclosure, an integrally bladed rotor (IBR) is provided. The IBR includes a hub and blades. Each blade includes an airfoil section to aerodynamically interact with a flow of air for compressing the air and a root fillet integrally formed with the hub and from which the airfoil section integrally extends. The root fillet includes a curved exterior surface having points of tangency with the airfoil section to define an outboard extent of the root fillet and a root fillet body between the hub and the outboard extent of the root fillet and defining a cutout for arresting a crack that is most likely to form and propagate.

In accordance with additional or alternative embodiments, the cutouts for the blades are symmetric about an axis of rotation of the hub.

In accordance with additional or alternative embodiments, the airfoil section includes a leading edge, a trailing edge and opposed pressure and suction surfaces extending between the leading edge and the trailing edge, the crack is most likely to form at the leading edge and to propagate axially rearwardly or at the trailing edge and to propagate axially forwardly and the cutout is defined along an expected propagation track of the crack most likely to form at the leading edge or at the trailing edge.

In accordance with additional or alternative embodiments, the root fillet further includes filler material differing from a material of the root fillet body disposed within the cutout.

In accordance with additional or alternative embodiments, an outer edge of the cutout is rounded.

In accordance with additional or alternative embodiments, the cutout extends through the root fillet body and has an elliptical shape oriented to present a long side to the crack that is most likely to form.

In accordance with additional or alternative embodiments, the cutout extends through the root fillet body and has a circular shape.

According to an aspect of the disclosure, an integrally bladed rotor (IBR) is provided. The IBR includes a hub and blades. Each blade includes an airfoil section to aerodynamically interact with a flow of air for compressing the air and a root fillet integrally formed with the hub and from which the airfoil section integrally extends. The root fillet includes a curved exterior surface having points of tangency with the airfoil section to define an outboard extent of the root fillet and a root fillet body between the hub and the outboard extent of the root fillet and defining a series of cutouts for arresting cracks that are most likely to form and propagate.

In accordance with additional or alternative embodiments, the series of the cutouts for the blades are symmetric about an axis of rotation of the hub.

In accordance with additional or alternative embodiments, the series of the cutouts defines a breakage line for a contained blade release event of the IBR.

In accordance with additional or alternative embodiments, the airfoil section includes a leading edge, a trailing edge and opposed pressure and suction surfaces extending between the leading edge and the trailing edge, the cracks are most likely to form at the leading edge and to propagate axially rearwardly or at the trailing edge and to propagate axially forwardly and the cutouts of the series of the cutouts are defined along expected propagation tracks of the cracks most likely to form at the leading edge or at the trailing edge.

In accordance with additional or alternative embodiments, the root fillet further includes filler material differing from a material of the root fillet body disposed within each cutout of the series of the cutouts.

In accordance with additional or alternative embodiments, an outer edge of each cutout of the series of the cutouts is rounded.

In accordance with additional or alternative embodiments, each cutout of the series of the cutouts extends through the root fillet body and has an elliptical shape oriented to present a long side to the corresponding crack that is most likely to form.

In accordance with additional or alternative embodiments, each cutout of the series of the cutouts extends through the root fillet body and has a circular shape.

According to an aspect of the disclosure, a method defining a mitigation strategy for hazardous airfoil cracks for an integrally bladed rotor (IBR) is provided wherein the IBR includes root fillets, each root fillet including a curved exterior surface having points of tangency with an airfoil section to define an outboard extent of the root fillet and a root fillet body between a hub and the outboard extent of the root fillet. The method includes analyzing root fillet dynamic and steady stress fields, analyzing field cracking history, performing crack growth simulations based on results of the analyses to determine likely crack propagation tracks into the root fillets, identifying locations for cutouts in the root fillets along the likely crack propagation tracks, analyzing a stress concentration impact of the cutouts and machining the cutouts through the root fillets in an event analysis results of the stress concentration impact are indicative of a limited impact.

In accordance with additional or alternative embodiments, the method further includes filling the cutouts with filler material.

In accordance with additional or alternative embodiments, the method further includes a secondary machining operation to round edges of the cutouts.

In accordance with additional or alternative embodiments, the machining includes at least one of forming the cutouts with an elliptical shape oriented to present a long side to a corresponding crack that is most likely to form and forming the cutouts with a circular shape.

In accordance with additional or alternative embodiments, the machining includes forming series of cutouts in each of the root fillets.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a partial cross-sectional view of a portion of an exemplary gas turbine engine in accordance with embodiments;

FIG. 2 is a perspective view of an IBR of a compressor section of the gas turbine engine of FIG. 1 in accordance with embodiments;

FIG. 3 is an enlarged perspective view of a portion of the IBR of FIG. 2 illustrating an outboard extend of a root fillet of an IBR in accordance with embodiments;

FIG. 4 is an enlarged perspective view of a portion of the IBR of FIG. 2 illustrating a cutout with filler material in accordance with embodiments;

FIG. 5 is an enlarged perspective view of a portion of the IBR of FIG. 2 illustrating a cutout with an elliptical shape in accordance with embodiments; and

FIG. 6 is an enlarged perspective view of a portion of the IBR of FIG. 2 illustrating a relative height range of a cutout and a root fillet as well as a series of cutouts in accordance with embodiments;

FIGS. 7A and 7B are a schematic illustration of a likely crack propagation track and a location of a cutout along the likely crack propagation track in accordance with embodiments;

FIG. 8 is a flow diagram illustrating a method defining a mitigation strategy for hazardous airfoil cracks for an IBR in accordance with embodiments;

FIGS. 9A and 9B illustrate steady state stress lines between a baseline case and a case in which a cutout is formed in an IBR in accordance with embodiments; and

FIGS. 10A and 10B illustrate dynamic stresses for a given mode shape between a baseline case and a case in which a cutout is formed in an IBR in accordance with embodiments.

### DETAILED DESCRIPTION

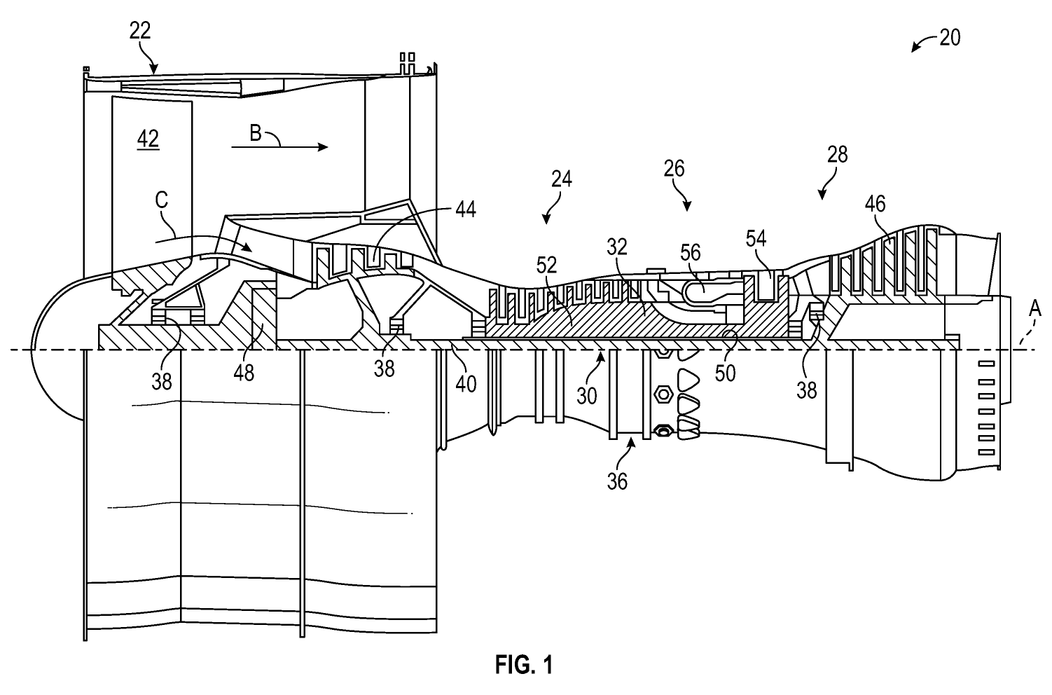

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary gas turbine engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

For gas turbine engines, such as the gas turbine engine 20 of FIG. 1, airfoils of IBRs are exposed to combined effects of environmental damage (FOD), low cycle fatigue (steady stress) and high cycle fatigue (vibratory stress). When the useful life of a component is exhausted and a crack is formed due to fatigue and/or service damage (nicks, dents from FOD, etc.), damage tolerance methods can be used to predict remaining crack propagation life and crack trajectory. Most often, cracks in the airfoil of an IBR will lead to a benign airfoil release for which the surrounding casing is already designed to withstand. However, cracks in the lower portion of the airfoil of an IBR pose a hazardous risk of propagating into the rotor body and resulting in an uncontained engine failure.

The lower portion of the airfoil of an IBR where a crack can propagate towards and into the rotor body is commonly abbreviated as “ARIZ”, which stands for the airfoil-rotor-interaction-zone.

During the design and certification of critical rotating parts, original equipment manufacturers (OEMs) are often required to demonstrate compliance to certain damage tolerance requirements, including probabilistic damage tolerance accounting for service damage observed in the field for the ARIZ. However, analytical prediction and assumptions are not always able to capture the entire range of dynamic stress seen in the engine flight envelope or all types of service damage that may be observed by the IBR. In such cases, although rare, undetected cracks in the ARIZ which nucleate due to higher than expected vibratory stress (flutter, acoustic resonance, icing, etc.) or severe damage (hard FOD, nicks, tears, etc.) can propagate and lead to hazardous failure modes.

When repeated hazardous modes of failure are observed in the field with common characteristics (initial crack location, FOD location, trajectory, fragment size, etc.), a field safety mitigation strategy is typically required. Most often, field mitigation is accomplished through routine scheduled inspection. However, it has been found that cracks that propagate from the ARIZ and into the disc are often driven by high-cycle-fatigue (HCF) and, due to the nature of HCF, high frequency modes can propagate cracks very quickly (<500 flights) even with relatively limited exposure (time) to the resonance speed.

Therefore, a need exists for strategies to mitigate risk of known and repeated hazardous modes of failure observed in the field for gas turbine engines with IBRs or for which a reasonable concern exists due to new learnings (i.e., higher than expected vibratory stresses, observed service damage, etc.).

Thus, as will be discussed below, a mitigation strategy for known hazardous or potentially hazardous modes of airfoil cracks for IBRs is proposed to arrest cracks that would eventually propagate into the rotor body and to provide ample time for the arrested cracks to be found through inspection. A cutout with, for example, a circular or elliptical shape, is formed within an airfoil root fillet section of an IBR. The shape, size and placement of the cutout is carefully adjusted such that cracks initiating from FOD prone or HCF limiting locations gravitate towards the cutout rather than propagating into the hub. When the active crack reaches the cutout, it will no longer be considered active since the tip of the crack is blunted by the cutout. The time required to generate a new crack on the cutout will provide opportunity to inspect for cracks and to remove the IBR out of service. Without the cutout, the crack would remain active and tend to propagate into the hub of the IBR with limited exposure time under HCF.

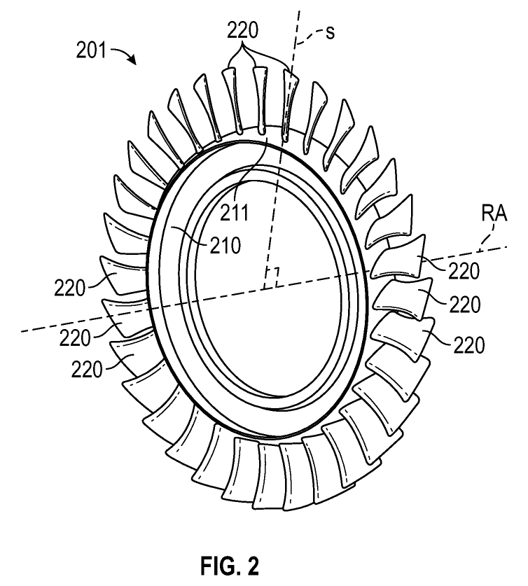

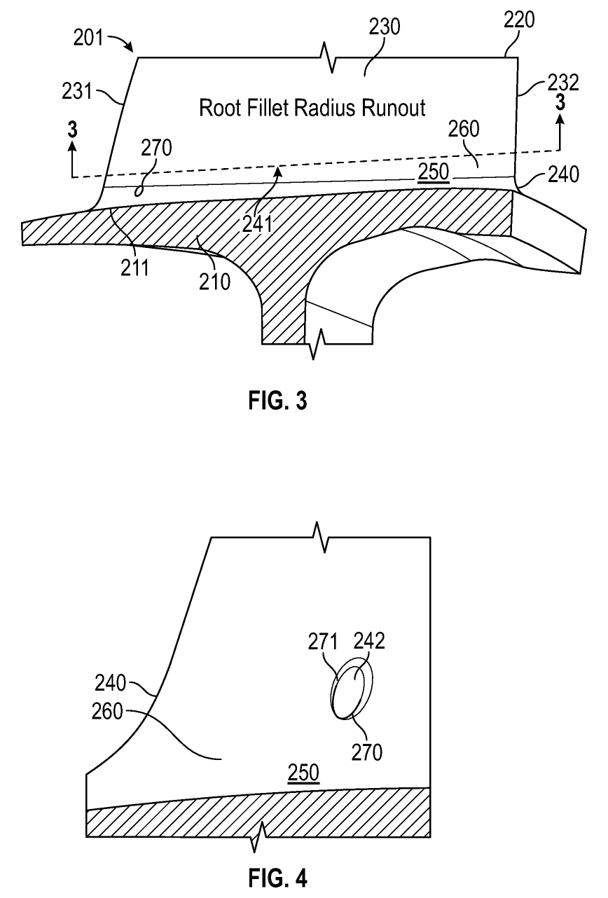

With reference to FIGS. 2 and 3, an IBR 201 is provided for use in at least the compressor section 24 of the gas turbine engine 20 of FIG. 1. The IBR 201 includes a hub 210 and non-removable, circumferentially arranged rotor blades (hereinafter referred to as “blades”) 220 that radially extend from the hub 210. The blades 220 can be integrally formed with the hub 210 so that the IBR 201 may be devoid of individual releasable blade attachments between the blades 220 and the hub 210. The IBR 201 may be referred to as a blade disk (“blisk”) or a bladed ring (“bling”). The hub 210 and the entire IBR 201 may have rotation axis RA and the hub 24 may include a platform 211 defining a part of the core flow path C of FIG. 1. The blades 220 may extend radially outwardly from the platform 211. Exemplary airfoil stacking line S is a reference line designating a position in space of a planar cross sections of a blade 220. The airfoil stacking line S may extend radially from rotation axis RA and may provide a frame of reference for a corresponding one of the blades 220.

Each blade 220 includes an airfoil section 230 to aerodynamically interact with a flow of air for compressing the air, a root fillet 240 integrally formed with the platform 211 of the hub 210 and from which the airfoil section 230 integrally extends along a radial dimension. The airfoil section 230 includes a leading edge 231, a trailing edge 232 and opposed pressure and suction surfaces extending between the leading edge 231 and the trailing edge 232. As shown in FIG. 3, the root fillet 240 includes a curved exterior surface 250 and a root fillet body 260. The curved exterior surface 250 has points of tangency identified by dashed line 3-3 with an inboard portion of the airfoil section 230 to define an outboard extent 241 of the root fillet 240.

While the dashed line 3-3 is illustrated as a straight line, it is to be understood that this is merely for illustrative and exemplary purposes. It is to be further understood that, for most blade designs, such as those with a twisting configuration, the points of tangency would form a curved line. The following description will relate to the case in which the dashed line 3-3 is straight, once again for purposes of clarity and brevity.

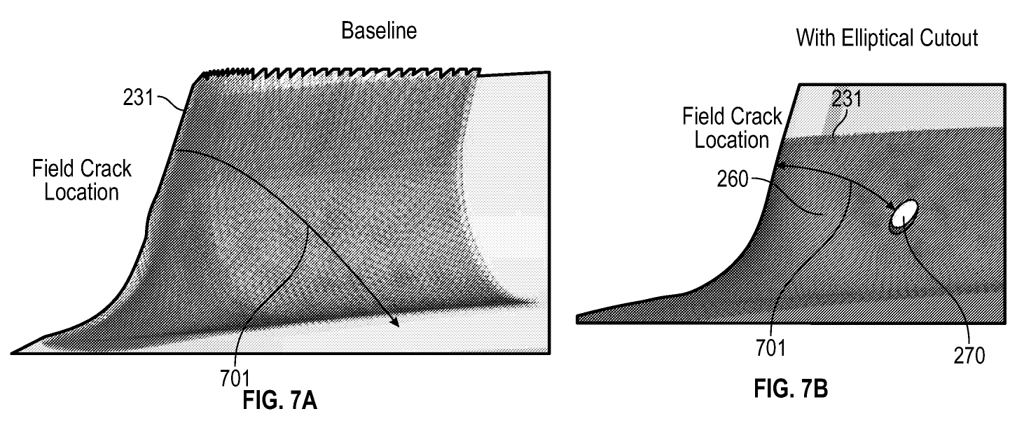

The root fillet body 260 is defined between the platform 211 of the hub 210 and the outboard extent 241 of the root fillet 240. The root fillet body 260 is formed to define a cutout 270 that is disposed and configured for arresting a possible crack that is most likely to form and propagate radially inwardly (see FIGS. 7A and 7B). Notably, the root fillet body 260 can be formed to define the cutout 270 though the crack may not have necessarily formed at the time the cutout 270 is formed. In accordance with embodiments, the cutout 270 can be provided as a cutout for multiple ones or all of the blades 210 in a symmetric arrangement about rotation axis RA.

It has been found that the crack is most likely to form at the leading edge 231 due, for example to FOD, low-cycle fatigue (LCF) and HCF, and to propagate axially rearwardly (and radially inwardly in some but not all cases) and to and through the root fillet 240. Of course, it is to be understood that cracks can form at other locations, such as at the trailing edge 232 and/or at mid-chord pressure side or suction side locations. In any case, in an event the crack is not arrested, the crack will then continue to propagate to the hub 210 and possibly lead to an uncontained engine failure and/or a disk fracture. In these or other cases, the cutout 270 is defined to extend through the foot fillet body 260 proximate to the leading edge 231 and along an expected propagation track of the crack in order to arrest the crack so that the IBR 201 can remain in service at least until a subsequent scheduled inspection. In some cases, it has also been found that the crack can be likely to form at the trailing edge 232 and to propagate axially forwardly and radially inwardly. In these or other cases, the cutout 270 is defined to extend through the root fillet body 260 proximate to the trailing edge 232 and along an expected propagation track of the crack in order to arrest the crack so that the IBR 201 can remain in service at least until a subsequent scheduled inspection.

For purposes of clarity and brevity and unless otherwise specified, the following description will generally relate to the cases in which the crack is most likely to form at the leading edge 231 and to propagate axially rearwardly and radially inwardly with the cutout 270 being defined to extend through the foot fillet body 260 proximate to the leading edge 231.

With continued reference to FIGS. 2 and 3 and with additional reference to FIG. 4, the root fillet 240 can further include filler material 242 disposed within the cutout 270. The filler material 242 can generally differ from a material of the root fillet body 260. In some cases, the filler material 242 can be provided as epoxy or other similar materials. In addition, as shown in FIG. 4, an outer edge 271 of the cutout 270 can be rounded or broken.

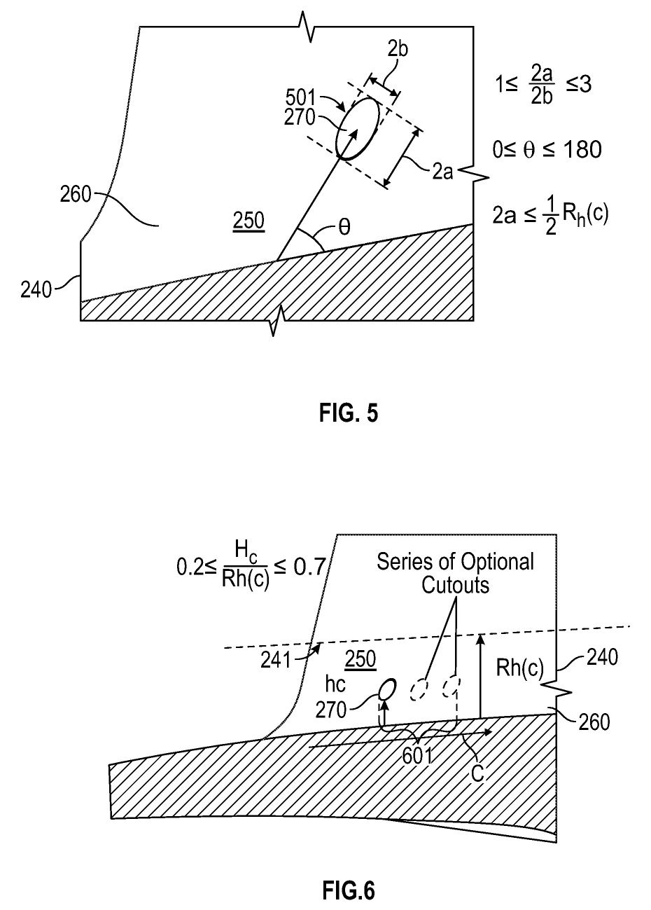

With continued reference to FIGS. 2 and 3 and with additional reference to FIG. 5, the cutout 270 extends through the root fillet body 260 and has one of an elliptical shape 501 and a circular shape as a specific case of the elliptical shape 501. In the case of the cutout 270 having the elliptical shape 501, the cutout 270 and the elliptical shape 501 are oriented to present a long side (i.e., a broadside) to the crack that is most likely to form (see FIGS. 7A and 7B). In accordance with embodiments, the orientation angle ϴ of the cutout 270 and the elliptical shape 501 can be between 0 and 180 degrees or, as shown in FIG. 5, between about 0 and about 90 degrees, between about 30-60 degrees or about 45 degrees. Where the cutout 270 is defined proximate to the trailing edge 232, the orientation angle ϴ of the cutout 270 and the elliptical shape 501 can be between about 180 and about 90 degrees, between about 30-60 degrees or about 45 degrees (i.e., reversed from what is shown in FIG. 5).

With continued reference to FIGS. 2 and 3 and with additional reference to FIG. 6, a height H_{c} of the cutout 270 can be expressed as a fractional height Rh(c) of a local portion of the root fillet 240. That is, as shown in FIG. 6, the height H_{c} of the cutout 270 can be about 20% to about 70% of the height Rh(c) of the local portion of the root fillet 240. It is to be understood, however, that this range is merely exemplary and that other ranges are possible (i.e., the height H_{c} of the cutout 270 can be about 10% or less to about 80% or more of the height Rh(c) of the local portion of the root fillet 240).

Additionally, as shown in FIG. 6, the root fillet body 260 can be formed to define a series 601 of cutouts 270 for arresting multiple cracks that are most likely to form and propagate radially inwardly. This series 601 of the cutouts 270 can again be symmetric about the rotation axis RA of the hub 210. In addition, the series 601 of the cutouts 270 can be arranged to define a breakage line through the series 601 of the cutouts 270 for promoting a contained blade release event of the IBR 201.

With reference to FIGS. 7A and 7B, IBR historical crack propagation data and root fillet stress concentration data can be compiled and analyzed to determine from analysis results likely crack propagation tracks into root fillets, such as the root fillet 240 of FIGS. 2-6 described above, whereupon locations for cutouts in the root fillets along the likely crack propagation tracks can be identified. This is illustrated schematically in FIGS. 7A and 7B. That is, FIG. 7A shows a rearward and radially inward likely crack propagation track 701 from a leading edge 231 that the historical crack propagation data predicts and FIG. 7B shows that cutout 270 is disposed to extend through the root fillet body 260 and along the likely crack propagation track 701 to arrest the crack before the crack forms and propagates or, more simply, before the crack propagates into the disk.

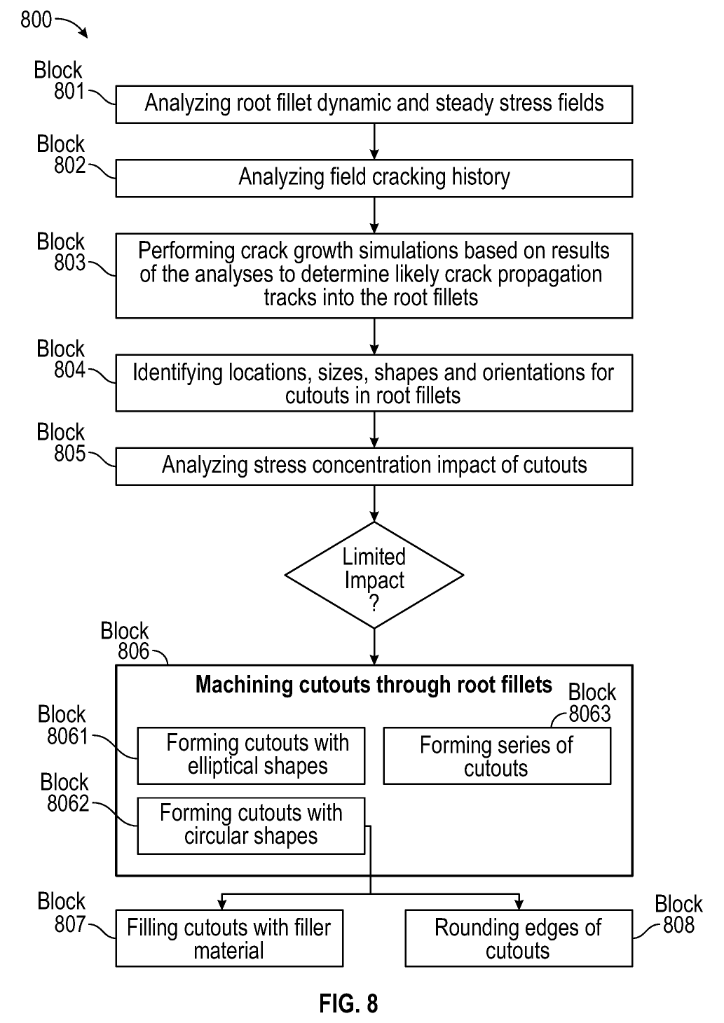

With reference to FIG. 8, a method 800 is provided to define a mitigation strategy for hazardous airfoil cracks for an IBR, such as the IBR 201 of FIG. 2 (and FIGS. 3-6). The method 800 includes analyzing root fillet dynamic and steady stress fields (block 801), analyzing field cracking history (block 802), performing crack growth simulations based on results of the analyses to determine likely crack propagation tracks into the root fillets (block 803), identifying locations, sizes, shapes and orientations for cutouts in the root fillets of IBRs (i.e., new IBRs or in-service IBRs to be retro-fitted) that are similar to the in-service IBRs that have been analyzed along the likely crack propagation tracks (block 804), analyzing a stress concentration impact of the cutouts (block 805) and machining the cutouts through the root fillets of IBRs (i.e., new IBRs or in-service IBRs to be retro-fitted) in an event analysis results of the stress concentration impact are indicative of a limited impact (block 806). In accordance with embodiments, the machining of block 806 can include at least one of forming the cutouts with an elliptical shape oriented to present a long side to a corresponding crack that is most likely to form (block 8061) and forming the cutouts with a circular shape (block 8062) and/or forming a series of cutouts in each of the root fillets (block 8063). In some cases, the method 800 can further include filling the cutouts with filler material (block 807) and a secondary machining operation to round edges of the cutouts (block 808).

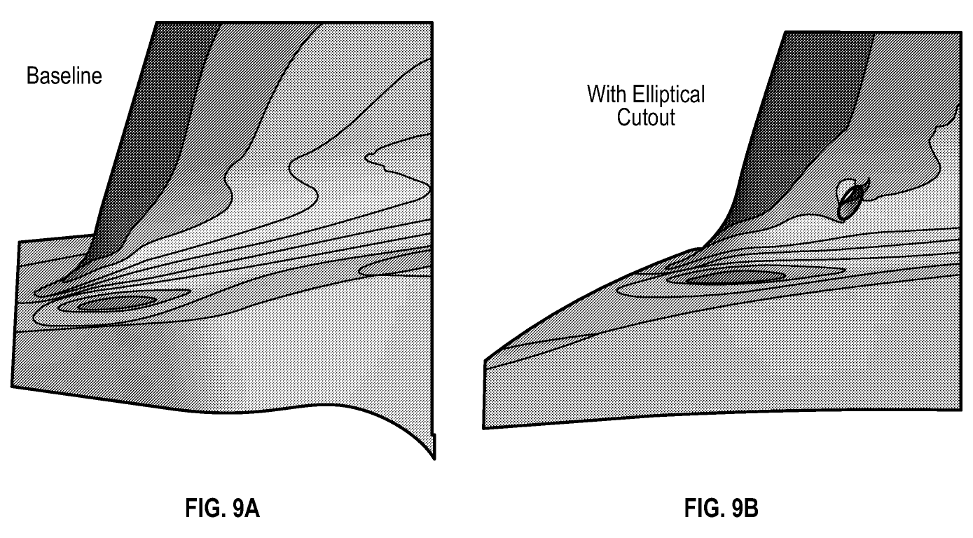

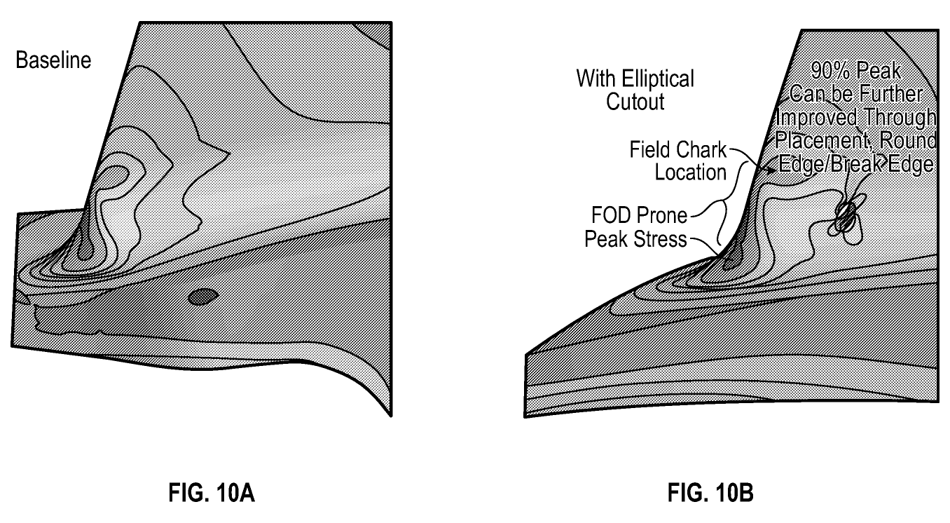

With continued reference to FIG. 8 and with additional reference to FIGS. 9A and 9B and to FIGS. 10A and 10B, the analysis of the root fillet stress concentration data of block 801 and the analysis of the stress concentration impact of the cutouts can include consideration of a steady state stress between a baseline instance and an instance in which a cutout is formed as shown in FIGS. 9A and 9B as well as consideration of dynamic stress between a baseline instance and an instance in which a cutout is formed as shown in FIGS. 10A and 10B. In the case of steady state stress of FIGS. 9A and 9B, the limited impact can be defined as an impact in which steady state stress lines are generally unchanged between the baseline instance and the instance in which a cutout is formed. Quantitively, this could mean that the steady state stress lines in the baseline instance and in the instance in which a cutout is formed are at least about 90% unchanged. In the case of dynamic stress of FIGS. 10A and 10B, the limited impact can be defined as an impact in which dynamic stress lines are generally unchanged between the baseline instance and the instance in which a cutout is formed. Quantitively, this could mean that the dynamic stress lines in the baseline instance and in the instance in which a cutout is formed are at least about 90% unchanged.

Regarding the above-noted percentages, it is to be understood that there is no strict criteria of how much % LCF or HCF stress fields can be changed as described herein as long as a risk of rotor fracture is not increased. That is, it may be preferable to reduce the risk of rotor fracture (through the cutout(s) 270) even at the increased risk of a blade release which is containable.

Technical effects and benefits of the present disclosure are the provision of a mitigation strategy for known hazardous modes of airfoil cracks for IBRs in which cracks that would eventually propagate into the rotor body are arrested and ample time is provided for the arrested cracks to be found through inspection.

Although holes have been used to arrest already propagating cracks, their success depends on initially finding active cracks through inspection and subsequently drilling. This can be difficult for cracks driven by HCF. In this disclosure, the cutout is machined prior to a crack being formed. As such, if HCF growth of a crack occurs, the crack could propagate into the cutout and be arrested and then found at the next opportunity for inspection.

While the addition of cutouts can form or lead to areas of stress concentration that can add additional sites for crack nucleation, an increase to the absolute risk of crack nucleation of the part can be minimized through careful adjustment (geometry/location) of the cutout in order to avoid creating or altering the peak risk location for which cracks have been observed and are most likely to occur (considering dynamic stress, steady stress, FOD, etc.). In any case, a tradeoff in the slightly increased absolute risk for crack nucleation is the benefit of delaying and/or arresting hazardous cracks and thereby increasing a probability of detecting cracks through field mitigation and/or management and reducing the risk of hazardous rotor failure.

As an additional advantage, the cutouts can potentially influence failure modes, thus remaking once hazardous cracks into contained blade release events.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An integrally bladed rotor (IBR), comprising:
a hub; and
blades, each blade comprising:
an airfoil section to aerodynamically interact with a flow of air for compressing the air; and
a root fillet integrally formed with the hub and from which the airfoil section integrally extends, the root fillet comprising:
a curved exterior surface having points of tangency with the airfoil section to define an outboard extent of the root fillet; and
a root fillet body between the hub and the outboard extent of the root fillet and defining a cutout for arresting a crack that is most likely to form and propagate.

2. The IBR according to claim 1, wherein the cutouts for the blades are symmetric about an axis of rotation of the hub.

3. The IBR according to claim 1, wherein:
the airfoil section comprises a leading edge, a trailing edge and opposed pressure and suction surfaces extending between the leading edge and the trailing edge,
the crack is most likely to form at the leading edge and to propagate axially rearwardly or at the trailing edge and to propagate axially forwardly, and
the cutout is defined along an expected propagation track of the crack most likely to form at the leading edge or at the trailing edge.

4. The IBR according to claim 1, wherein the root fillet further comprises filler material differing from a material of the root fillet body disposed within the cutout.

5. The IBR according to claim 1, wherein an outer edge of the cutout is rounded.

6. The IBR according to claim 1, wherein the cutout extends through the root fillet body and has an elliptical shape oriented to present a long side to the crack that is most likely to form.

7. The IBR according to claim 1, wherein the cutout extends through the root fillet body and has a circular shape.

8. An integrally bladed rotor (IBR), comprising:
a hub; and
blades, each blade comprising:
an airfoil section to aerodynamically interact with a flow of air for compressing the air; and
a root fillet integrally formed with the hub and from which the airfoil section integrally extends, the root fillet comprising:
a curved exterior surface having points of tangency with the airfoil section to define an outboard extent of the root fillet; and
a root fillet body between the hub and the outboard extent of the root fillet and defining a series of cutouts for arresting cracks that are most likely to form and propagate.

9. The IBR according to claim 8, wherein the series of the cutouts for the blades are symmetric about an axis of rotation of the hub.

10. The IBR according to claim 8, wherein the series of the cutouts defines a breakage line for a contained blade release event of the IBR.

11. The IBR according to claim 8, wherein:
the airfoil section comprises a leading edge, a trailing edge and opposed pressure and suction surfaces extending between the leading edge and the trailing edge,
the cracks are most likely to form at the leading edge and to propagate axially rearwardly or at the trailing edge and to propagate axially forwardly, and
the cutouts of the series of the cutouts are defined along expected propagation tracks of the cracks most likely to form at the leading edge or at the trailing edge.

12. The IBR according to claim 8, wherein the root fillet further comprises filler material differing from a material of the root fillet body disposed within each cutout of the series of the cutouts.

13. The IBR according to claim 8, wherein an outer edge of each cutout of the series of the cutouts is rounded.

14. The IBR according to claim 8, wherein each cutout of the series of the cutouts extends through the root fillet body and has an elliptical shape oriented to present a long side to the corresponding crack that is most likely to form.

15. The IBR according to claim 8, wherein each cutout of the series of the cutouts extends through the root fillet body and has a circular shape.

16. A method defining a mitigation strategy for hazardous airfoil cracks for an integrally bladed rotor (IBR) comprising root fillets, each root fillet comprising a curved exterior surface having points of tangency with an airfoil section to define an outboard extent of the root fillet and a root fillet body between a hub and the outboard extent of the root fillet, the method comprising:
analyzing root fillet dynamic and steady stress fields;
analyzing field cracking history;
performing crack growth simulations based on results of the analyses to determine likely crack propagation tracks into the root fillets;
identifying locations for cutouts in the root fillets along the likely crack propagation tracks;
analyzing a stress concentration impact of the cutouts; and
machining the cutouts through the root fillets in an event analysis results of the stress concentration impact are indicative of a limited impact.

17. The method according to claim 16, further comprising filling the cutouts with filler material.

18. The method according to claim 16, further comprising a secondary machining operation to round edges of the cutouts.

19. The method according to claim 16, wherein the machining comprises at least one of forming the cutouts with an elliptical shape oriented to present a long side to a corresponding crack that is most likely to form and forming the cutouts with a circular shape.

20. The method according to claim 16, wherein the machining comprises forming series of cutouts in each of the root fillets.
